(19) United States
(12) Patent Application Publication
(10) Pub. No.: US 2007/0180523 A1
(43) Pub. Date: Aug. 2, 2007

(54) METHOD AND SYSTEM FOR TRACKING USAGE OF ON-LINE CONTENT

(76) Inventors: Tomas Jablonski, Avon, CO (US); Richard Schmelzer, Boulder, CO (US)

Correspondence Address: COOLEY GODWARD KRONISH LLP;ATTN: Patent Group, Suite 500, 1200 - 19th Street, NW, WASHINGTON, DC, 20036-2402, US

(21) Appl. No.: 11/558,197

(22) Filed: Nov. 9, 2006

Related U.S. Application Data
(60) Provisional application No. 60/735,004, filed on Nov. 9, 2005.

(51) Int. Cl. G06F 12/14

(52) U.S. Cl. 726/22

(57) ABSTRACT

A method and system for tracking usage of on-line content is described. One embodiment adds to the on-line content an embedded executable object, the embedded executable object being executable by a client computer requesting the on-line content from a server, the embedded executable object being configured to be launched by a first tag added to the on-line content by a republisher of the on-line content, the first tag including dynamic usage-tracking information that is passed to the embedded executable object, the embedded executable object being configured to add to the on-line content a second tag during execution of the embedded executable object on the client computer, the second tag including a link that, when accessed by the client computer, causes a usage-tracking function on a server associated with a source of the on-line content to be executed, the usage-tracking function being configured to receive the dynamic usage-tracking information via the link; and saves the on-line content to which the embedded executable object has been added.

### PRIORITY

The present application claims priority from commonly owned and assigned application No. 60/735,004, Attorney Docket No. MODY-003/00US, entitled FOR USAGE TRACKING ON WEBSITE AND RSS FEEDS, which is incorporated herein by reference.

### RELATED APPLICATIONS

The present application is related to commonly owned and assigned application Ser. No. 11/455,127, Attorney Docket No. MODY-002/01US, entitled CONTENT ENHANCEMENT BASED ON CONTEXTUAL DATA WITHIN A FEED, which is incorporated herein by reference.

### FIELD OF THE INVENTION

The present invention relates generally to the publishing of on-line content. In particular, but not by way of limitation, the present invention relates to methods and systems for tracking usage of on-line content.

### BACKGROUND OF THE INVENTION

Publishers of on-line content want to track the usage and popularity of their content. This helps the publisher measure the effectiveness of the content and helps the publisher improve the user experience. On-line content includes, for example, Web sites and Web feeds.

One common type of Web feed is the so-called RSS feed. “RSS” is variously used to refer to Really Simple Syndication (RSS 2.0), Rich Site Summary (RSS 0.91 and 1.0), or RDF Site Summary (RSS 0.9 and 1.0). An RSS feed is a simple system based on Extensible Markup Language (XML) that allows users to subscribe to their favorite Web sites. A program known as a feed reader or aggregator checks a list of feeds on behalf of a user and displays any updated articles it finds.

One aspect of usage tracking is the ability to count individual instances of a user's viewing specific elements of a Web page or Web feed despite these elements having been republished in third party Web sites or feeds. This has traditionally been accomplished by embedding an invisible one-pixel image in the content. The viewer's browser always fetches this image from the original publisher's Web site regardless of which site on which the content is published. That makes it possible for the original publisher's Web server to count occurrences of viewings of the element in question. In addition, the Uniform Resource Locator (URL) used to fetch the invisible image may contain additional information identifying the content, time of publishing, and so forth. The process of fetching the invisible image is sometimes referred to as “pinging the source site.”

This method has several drawbacks. The most important drawback occurs when the content is republished by a third party. The publisher and the republisher may want to customize the exact ping URL “on the fly,” for example, to add the republisher's ID or some information uniquely identifying the viewer (end user). Without an identifying ID of the end user, the publisher ends up counting pings instead of distinct users. Since a given end user may access content multiple times, this approach provides potentially inaccurate usage data. Providing a specific end-user ID is impossible with static, embedded-invisible-image pings unless the republisher undertakes a relatively difficult and error-prone task of parsing the content and changing the URLs of the invisible image pings to insert the additional information.

It is thus apparent that there is a need in the art for an improved method and system for tracking usage of on-line content.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a method and system for tracking usage of on-line content. One illustrative embodiment is a method for tracking usage of on-line content, comprising adding to the on-line content an embedded executable object, the embedded executable object being executable by a client computer requesting the on-line content from a server, the embedded executable object being configured to be launched by a first tag added to the on-line content by a republisher of the on-line content, the first tag including dynamic usage-tracking information that is passed to the embedded executable object, the embedded executable object being configured to add to the on-line content a second tag during execution of the embedded executable object on the client computer, the second tag including a link that, when accessed by the client computer, causes a usage-tracking function on a server associated with a source of the on-line content to be executed, the usage-tracking function being configured to receive the dynamic usage-tracking information via the link; and saving the on-line content to which the embedded executable object has been added.

Another illustrative embodiment is a system for tracking usage of on-line information, comprising an embedded-executable-object-insertion module configured to add to the on-line content an embedded executable object, the embedded executable object being executable by a client computer requesting the on-line content from a server, the embedded executable object being configured to be launched by a first tag added to the on-line content by a republisher of the on-line content, the first tag including dynamic usage-tracking information that is passed to the embedded executable object, the embedded executable object being configured to add to the on-line content a second tag during execution of the embedded executable object on the client computer, the second tag including a link that, when accessed by the client computer, causes a usage-tracking function on a server associated with a source of the on-line content to be executed, the usage-tracking function being configured to receive the dynamic usage-tracking information via the link; and a save-modified-content module configured to save the on-line content to which the embedded-executable-object-insertion module has added the embedded executable object. These and other embodiments are described in greater detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a block diagram of an environment in which various embodiments of the invention can be implemented;

FIG. 2A is a simplified facsimile of a Web page before a republisher has served it to an end user's browser in accordance with an illustrative embodiment of the invention;

FIG. 2B is a simplified facsimile of a Web page after a republisher has served it to an end user's browser in accordance with an illustrative embodiment of the invention;

FIG. 3 is a process flow diagram of an illustrative embodiment of the invention.

FIG. 4 is a functional block diagram of a publisher's server equipped with a content-usage tracking system in accordance with an illustrative embodiment of the invention; and

FIG. 5 is a flowchart of a method for tracking usage of on-line content in accordance with an illustrative embodiment of the invention.

### DETAILED DESCRIPTION

In this Detailed Description, reference is made to “publishers” or “content sources”; “consumers,” “viewers,” or “users”; and “republishers.” A “publisher” or “content source” generates content for on-line publication to a public or private audience. A “consumer,” “viewer,” or “end user” views or otherwise makes use of the on-line content. A “republisher” republishes on-line content with the permission of the original publisher. Some examples of republishers include Bloglines and Slashdot. Bloglines is a provider of RSS feeds. Slashdot provides Web pages with user-selectable levels of detail. As used herein, “on-line content” (or “content”) includes, without limitation, Web sites and Web feeds such as RSS feeds.

In an illustrative embodiment of the invention, a publisher or content source adds an embedded executable object to its content. This embedded executable object is configured to receive dynamic usage-tracking information from a tag added to the content by a republisher of the content in accordance with an agreement between the publisher and the republisher. The tag added by the republisher calls the embedded executable object when the content is served to a consumer's browser and passes the dynamic usage-tracking information to the embedded executable object. The embedded executable object uses the dynamic usage-tracking information to add another tag to the content, this additional tag also being processed by the viewer's browser when the page is served to the client computer. The tag added by the embedded executable object calls a server-side executable program on the publisher's server that receives and processes the dynamic usage-tracking information supplied by the republisher. In some embodiments, the embedded executable object adds multiple tags to the content for more comprehensive tracking of the usage of specific elements of the content.

In some embodiments, the embedded executable object is a script program. For example, the embedded executable object can be implemented using JAVASCRIPT, Document Object Model (DOM), ACTIONSCRIPT, or other scripting language that is executable by a Web browser or feed reader.

The dynamic information may include a unique republisher ID, unique consumer ID, demographic information about the consumer such as age or gender, or any other information about the consumer that the republisher agrees to share with the publisher that would not violate the consumer's privacy or expose the content usage tracking system to spoofing. A republisher normally desires to keep its user IDs (customer IDs) private. In some embodiments, the consumer's ID is encrypted to protect the underlying customer ID assigned by the republisher. So long as the mapping from the unencrypted consumer ID to the encrypted consumer ID is one to one, the publisher receives the desired information about the usage of the content without compromising the consumer's privacy. Though the identity of each individual consumers remains unknown, it is still possible to distinguish each consumer from all other consumers for counting purposes.

Usage tracking according to this illustrative embodiment can be applied to specific parts of a Web page. Examples include frames within a Web page or content on a Web page that requires an additional click before it is loaded (sometimes called conditionally loaded content).

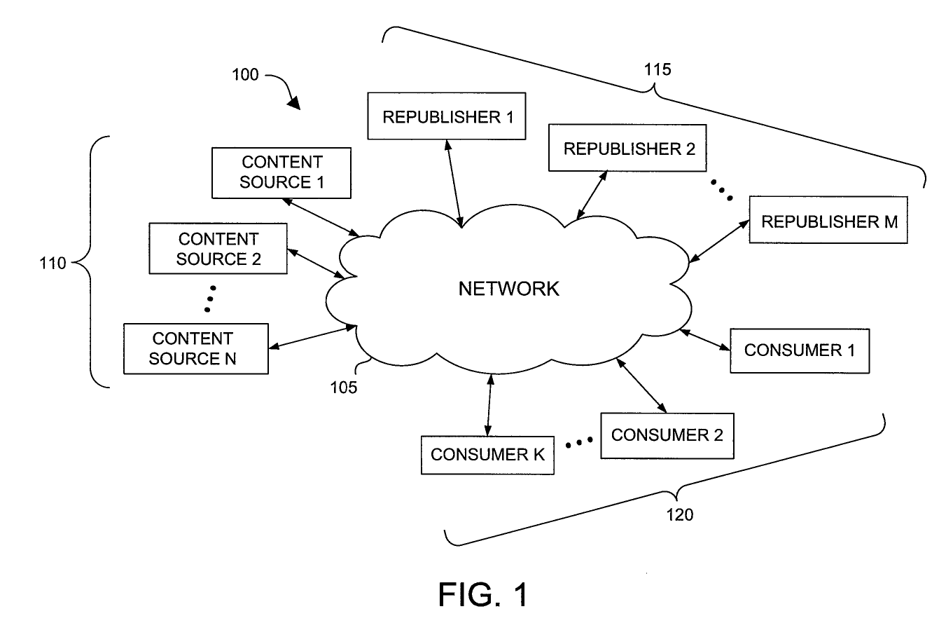

Referring now to the drawings, where like or similar elements are designated with identical reference numerals throughout the several views and referring in particular to FIG. 1, it is a block diagram of an environment 100 in which various embodiments of the invention can be implemented. In FIG. 1, a network 105, such as the Internet, connects N content sources 110, Mrepublishers 115, and K consumers 120. Associated with each content source 110 and each republisher 115 is at least one server. Associated with each consumer 120 is at least one client computer. Republishers 115 republish content created by publishers 110 with the permission of publishers 110. Republishers 115 serve the on-line content to consumers 120 as, for example, Web pages or Web feeds. Consumers 120 use a Web browser or feed aggregator on a client computer to view the content provided by content sources 110 or republishers 115.

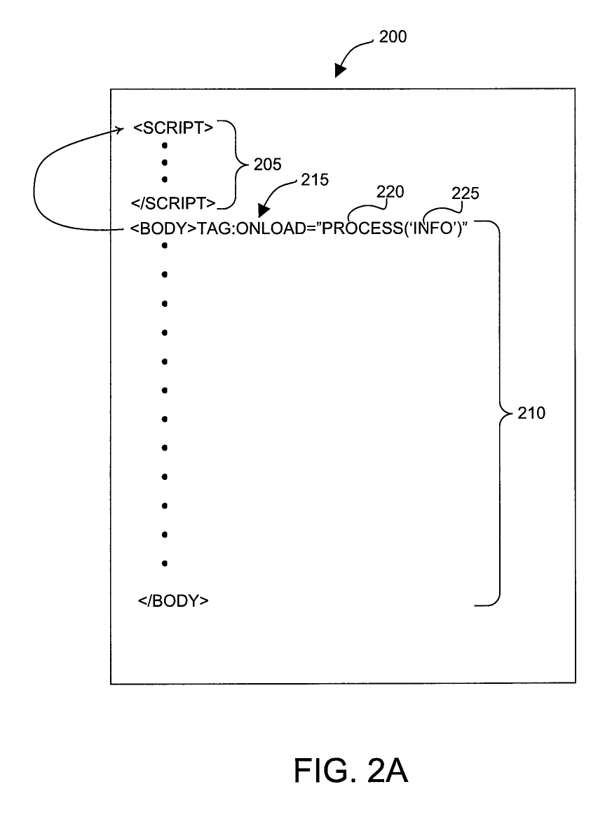

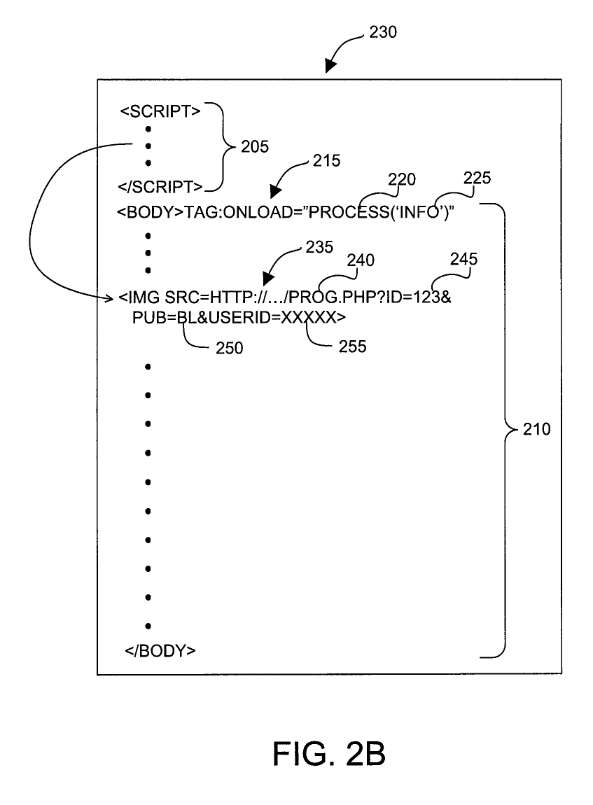

FIG. 2A is a simplified facsimile of a Web page 200 before a republisher has served it to a consumer's browser in accordance with an illustrative embodiment of the invention. A Web page such as Web page 200 is typically represented in Hypertext Markup Language (HTML). The publisher or content source 110 for Web page 200 adds an embedded executable object 205 to Web page 200. Body 210 of Web page 200 begins with body tag 215, which is added to the content by a republisher 115 in accordance with an arrangement between the republisher 115 and the publisher 110. Body tag 215 includes a function call 220 to a function arbitrarily named “PROCESS” in this example. Function call 220 calls embedded executable object 205, causing embedded executable object 205 to be executed by the requesting consumer's browser. Function call 220 also passes dynamic usage-tracking information 225 (“INFO” in FIG. 2A) as arguments to embedded executable object 205.

The example of FIG. 2A in which body tag 215 is used to call embedded executable object 205 is merely one possible implementation. In other embodiments, embedded executable object 205 is called by one or more tags located within the body 210 of the Web page.

In this illustrative embodiment, the republisher 115 agrees to retain embedded executable object 205 in the content, to add the customized body tag 215 (or one or more other suitable tags within body 210) that calls embedded executable object 205, and to supply dynamic usage-tracking information 225. Dynamic usage-tracking information 225 includes information such as a republisher ID, a unique consumer ID, or other information about the consumer 120 requesting Web page 200.

FIG. 2B is a simplified facsimile of a Web page 230 after a republisher has served it to a consumer's browser in accordance with an illustrative embodiment of the invention. When republisher 115 serves Web page 200 to the consumer's browser, the consumer's browser executes embedded executable object 205 in accordance with the body tag 215 that was added to the content by the republisher 115. Embedded executable object 205 generates modified Web page 230 by adding a usage-tracking tag 235 to Web page 200. In the example of FIG. 2B, usage-tracking tag 235 is an image-source (“IMG SRC”) tag.

Usage-tracking tag 235 contains a link to a server-side executable 240 (“PROG.PHP” in this example) that resides on the original publisher's server. The link to server-side executable 240 includes, in this illustrative embodiment, a unique content identifier 245 (“123” in this example), a republisher ID 250 (“BL” in this example for “Bloglines”), and a unique consumer ID 255 (represented by “XXXXX” in this example). As mentioned above, the unique consumer ID 255 is encrypted in some embodiments.

The consumer's browser accesses the link contained in usage-tracking tag 235, causing the server-side executable 240 to be executed. Server-side executable 240 is configured to receive and process dynamic usage-tracking information 225 such as republisher ID 250 and unique consumer ID 255. Based on this received information, publisher 110 can track usage of its content that is republished by republisher 115. The dynamic usage-tracking information 225 that is passed to publisher 110 via usage-tracking tag 235 informs publisher 110 from which republisher 115 the content was accessed and which unique consumer 120 accessed the content. A publisher 110 can use this information to count the number of accesses by distinct consumers 120 during a particular period of interest.

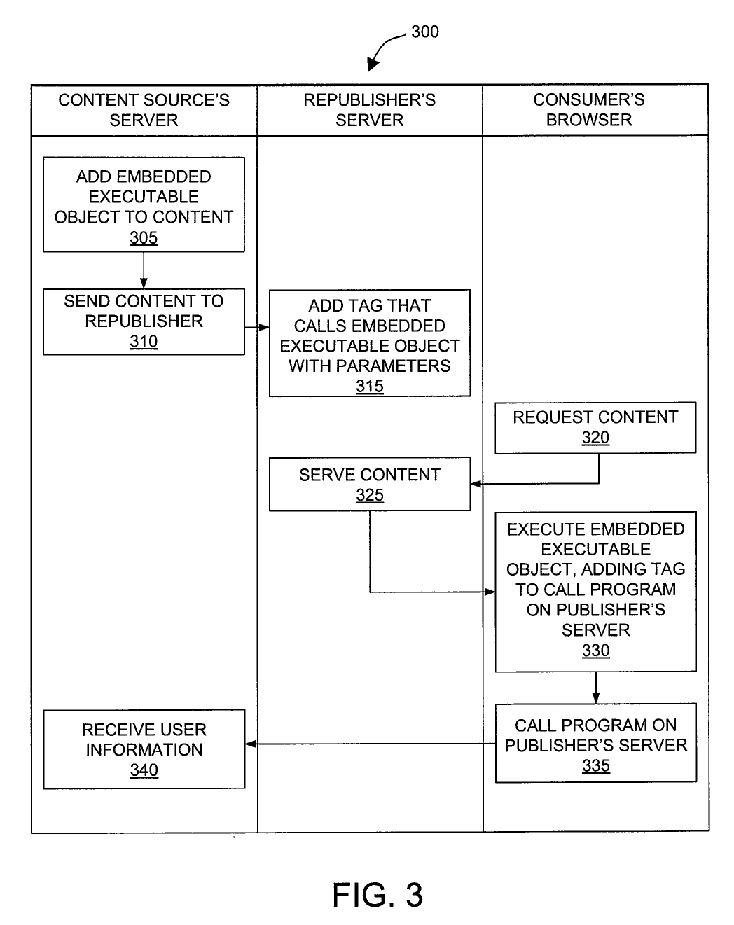

FIG. 3 is a process flow diagram 300 of an illustrative embodiment of the invention. At 305, the content source's server adds an embedded executable object 205 to the content whose usage is to be tracked. The content, now including an embedded executable object 205, is sent to the republisher's server at 310. At 315, the republisher's server adds one or more tags to the content to call embedded executable object 205 with arguments providing dynamic usage-tracking information 225. At 320, a consumer's browser requests the content from the republisher's server. The republisher's server serves the requested content to the consumer's browser at 325. At 330, the consumer's browser processes body tag 215 (or other tag), causing embedded executable object 205 to be executed on the client side. Embedded executable object 205 adds usage-tracking tag 235 to the content. When the consumer's browser accesses the link contained within usage-tracking tag 235, server-side executable 240 on the publisher's server is executed at 335. At 340, the content source's server receives dynamic usage-tracking information 225.

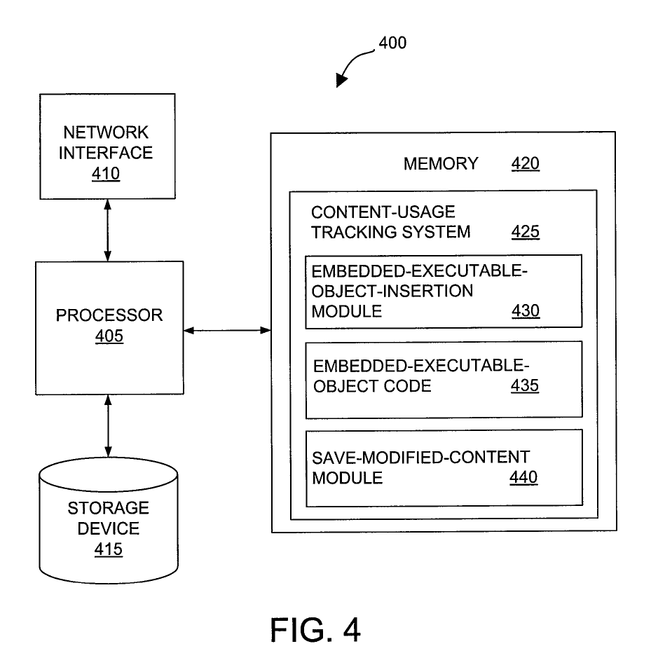

FIG. 4 is a functional block diagram of a publisher's server 400 equipped with a content-usage tracking system in accordance with an illustrative embodiment of the invention. In FIG. 4, processor 405 is in communication with network interface 410, storage device 415, and memory 420. Memory 420 includes content-usage-tracking system 425. For convenience in this Detailed Description, content-usage tracking system 425 has been divided into a set of functional modules. In this illustrative embodiment, the functional modules include embedded-executable-object-insertion module 430, embedded-executable-object code 435, and save-modified-content module 440.

Embedded-executable-object-insertion module 430 inserts embedded executable object 205 into the content. Embedded-executable-object code 435 is a copy of the program instructions (e.g., in a scripting language) constituting embedded executable object 205. Save-modified-content module 440 saves the modified content to which embedded executable object 205 has been added by content source 110.

The functionality of modules 430, 435, and 440 may be subdivided or combined differently in other embodiments. In one embodiment, the functionality of content-usage-tracking system 425 is implemented as software or firmware executed by processor 405. In general, the functionality of content usage tracking system 425 may be implemented in software, firmware, hardware, or any combination thereof.

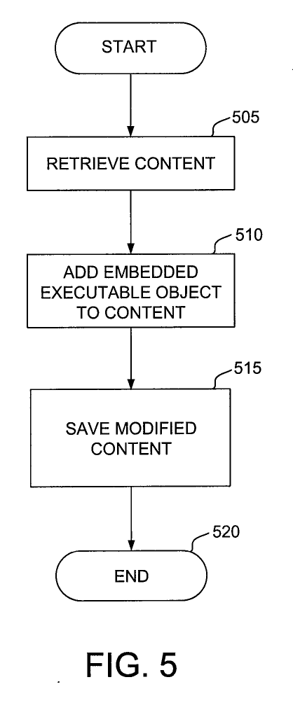

FIG. 5 is a flowchart of a method for tracking usage of on-line content in accordance with an illustrative embodiment of the invention. At 505, the publisher's server retrieves the content to which usage-tracking capability is to be added. At 510, embedded-executable-object-insertion module 430 adds embedded executable object 205 to the content. Save-modified-content module 440 then saves the modified content at 515. At 520, the process terminates.

In conclusion, the present invention provides, among other things, a method and system for tracking usage of on-line content. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for tracking usage of on-line content, comprising:
adding to the on-line content an embedded executable object, the embedded executable object being executable by a client computer requesting the on-line content from a server, the embedded executable object being configured to be launched by a first tag added to the on-line content by a republisher of the on-line content, the first tag including dynamic usage-tracking information that is passed to the embedded executable object, the embedded executable object being configured to add to the on-line content a second tag during execution of the embedded executable object on the client computer, the second tag including a link that, when accessed by the client computer, causes a usage-tracking function on a server associated with a source of the on-line content to be executed, the usage-tracking function being configured to receive the dynamic usage-tracking information via the link; and
saving the on-line content to which the embedded executable object has been added.

2. The method of claim 1, further comprising:
transmitting to a republisher via a network the on-line content to which the embedded executable object has been added.

3. The method of claim 1, wherein the on-line content is a Web page.

4. The method of claim 1, wherein the on-line content is a Web feed.

5. The method of claim 1, wherein the embedded executable object is implemented using one of JAVASCRIPT, Document Object Model, and ACTIONSCRIPT.

6. The method of claim 1, wherein the dynamic usage-tracking information includes at least one of a republisher identifier, a unique identifier of a consumer associated with the client computer, and demographic information about the consumer.

7. The method of claim 6, wherein the unique identifier of the consumer associated with the client computer is encrypted.

8. The method of claim 1, wherein the first tag is a markup-language “body” tag.

9. The method of claim 1, wherein the embedded executable object is capable of being called by any of a plurality of tags added by the republisher, each tag in the plurality of tags being capable of supplying dynamic usage-tracking information associated with a specific portion of the on-line content.

10. A system for tracking usage of on-line content, comprising:
an embedded-executable-object-insertion module configured to add to the on-line content an embedded executable object, the embedded executable object being executable by a client computer requesting the on-line content from a server, the embedded executable object being configured to be launched by a first tag added to the on-line content by a republisher of the on-line content, the first tag including dynamic usage-tracking information that is passed to the embedded executable object, the embedded executable object being configured to add to the on-line content a second tag during execution of the embedded executable object on the client computer, the second tag including a link that, when accessed by the client computer, causes a usage-tracking function on a server associated with a source of the on-line content to be executed, the usage-tracking function being configured to receive the dynamic usage-tracking information via the link; and
a save-modified-content module configured to save the on-line content to which the embedded-executable-object-insertion module has added the embedded executable object.

11. The system of claim 10, further comprising:
a network interface to transmit to a republisher via a network the on-line content to which the embedded-executable-object-insertion module has added the embedded executable object.

12. The system of claim 10, wherein the on-line content is a Web page.

13. The system of claim 10, wherein the on-line content is a Web feed.

14. The system of claim 10, wherein the embedded executable object is implemented using one of JAVASCRIPT, Document Object Model, and ACTIONSCRIPT.

15. The system of claim 10, wherein the dynamic usage-tracking information includes at least one of a republisher identifier, a unique identifier of a consumer associated with the client computer, and demographic information about the consumer.

16. The system of claim 15, wherein the unique identifier of the consumer associated with the client computer is encrypted.

17. The system of claim 10, wherein the embedded executable object is capable of being called by any of a plurality of tags added by the republisher, each tag in the plurality of tags being capable of supplying dynamic usage-tracking information associated with a specific portion of the on-line content.

18. A method for republishing on-line content, comprising:
adding to the on-line content a first tag that launches an embedded executable object in the on-line content when the first tag is processed by a client computer requesting the on-line content, the embedded executable object having been added to the on-line content previously by an originator of the on-line content; and
including in the first tag dynamic usage-tracking information that is passed to the embedded executable object, the embedded executable object being configured to add to the on-line content a second tag during execution of the embedded executable object on the client computer, the second tag including a link that, when accessed by the client computer, causes a usage-tracking function on a server associated with the originator of the on-line content to be executed, the usage-tracking function being configured to receive the dynamic usage-tracking information via the link.

19. The method of claim 18, further comprising:
republishing on a server connected with a network the on-line content to which the first tag has been added.

20. The method of claim 18, wherein the on-line content is one of a Web page and a Web feed.

21. The method of claim 18, wherein the dynamic usage-tracking information includes at least one of a republisher identifier, a unique identifier of a consumer associated with the client computer, and demographic information about the consumer.

22. The method of claim 21, wherein the unique identifier of the consumer associated with the client computer is encrypted.

23. The method of claim 18, wherein a plurality of tags are added to the on-line content, each tag in the plurality of tags being capable of supplying to the embedded executable object dynamic usage-tracking information associated with a specific portion of the on-line content.

24. A system for tracking usage of on-line content, comprising:
a server associated with a source of the on-line content configured to:
add an embedded executable object to the on-line content to generate first modified on-line content; and
send the first modified on-line content to a republisher via a network;
a server associated with the republisher configured to:
add a first tag to the modified on-line content to generate second modified on-line content, the first tag including dynamic usage-tracking information;
a client computer configured to request, via the network, the second modified on-line content from the server associated with the republisher, the client computer being equipped with an application that, responsive to the first tag, executes the embedded executable object, the embedded executable object being configured to add to the second modified on-line content a second tag, the second tag including a link that, when accessed by the application on the client computer, causes a usage-tracking function on the server associated with the source of the on-line content to be executed, the usage-tracking function being configured to receive the dynamic usage-tracking information via the link.
